(19) United States
(12) Patent Application Publication
(10) Pub. No.: US 2015/0324932 A1
(43) Pub. Date: Nov. 12, 2015

(54) Online banking balance and verification

(71) Applicant: John Milner McCary, SR., Birmingham, AL (US)

(72) Inventor: John Milner McCary, SR., Birmingham, AL (US)

(21) Appl. No.: 14/120,223

(22) Filed: May 8, 2014

(51) Int. Cl. G06Q 40/00

(52) U.S. Cl. CPC G06Q 40/128; G06Q 40/02

(57) ABSTRACT

The current invention is a system and method to help obtain and verify an online banking account balance. An image or digital copy of the checking or accounting income and expense register is sent to the online account financial institution. Character recognition software reads the register's image entries. An attempted corrected and updated online banking account report is generated which includes; checks that have not been cashed, date drawn, payees, plus any adjustments to income and expenses, and/or deposits and withdrawals entries. The online checking account system may be able to provide more information of online account entries where the account holder may need verification. There may be offline or online entry information searches by the online banking system and the account holder may be able to contact the payee, payor, depositor and/or withdrawer directly through online banking system.

### FIELD OF THE INVENTION

The present invention relates to systems and methods to maintain an updated more accurate financial report in connection with an online banking account.

### BACKGROUND OF THE INVENTION

Individuals, businesses and organizations have the benefit of using online banking to manage their financial accounts while in the same account may also use paper checks for some transactions. Most anytime the various financial account's transactions and balances can be obtained by logging on to the enrolled financial institutions online banking account. Transactions of credit cards, debit cards, across institution transfers, online payment accounts, other payment methods plus the ability to communicate with the financial institution is at most times updated on a real-time basis. There may be also near real-time reporting by the financial institution where there are pending debit or credit transactions. Because of the real-time basis of the online banking reporting many users may rely on the on line account balances as an adequate approximation for their financial account balance and funds available for other purchases. If paper checks are periodically written then solely relying on the on-line account reporting balance may present accurate financial account difficulties.

Unlike the real-time and digital payment method that is used very commonly today, payment by more traditional paper checks does not generate any electronic record at the time of drafting the check and transfer of the check from account holder to the payee. There is no immediate use of any computer network to communicate to the financial institution that holds the account of the drafted check that the check has been drawn. There may be a substantial amount of time passed before the payee of the drafted check actually cashes the drawn check. During the check drawn and the check cashed period of time the drawn check will not appear as a pending payment in the online banking account of the account holder. If the account holder does not account for the drawn check and relies upon the balance information in the online banking reporting, there will be an overstatement of the amount of funds available. The account could be overdrawn when the payee cashes the drawn check.

A difficulty may arise on occasion where the checking account or accounting book income, expenses, and/or deposits and withdrawals may not correctly match or may even be not accounted for on the online banking account. The reverse may sometimes occur where the online banking account may show entries that are not entered or incorrectly entered on the account holder's registers.

Another often difficulty associated with an online banking account is the usual inadequate information in the financial institution online report entries. Many times it is very hard to actually determine on the report: who the payee was, what was purchase and for how much for particular items. In most credit or debit card in person direct from the payee purchases, and especially online transactions, the purchaser does not keep the transaction receipt or inter the purchase information in the checking account register, or even sometimes in the accounting book's register. The online banking consumer many times cannot remember the details of the credit/debit or online purchase. There may be fraudulent purchases on the banking account and the online account holder, who may primarily rely on the online financial institution reports, to be unable to get further online information of a questionable purchase.

What is needed is an improved system and method for a more accurate entry accounting in connection with an online banking account. The account holder needs to be able to also expand the entry information in the financial institutions online report to adequately be able to recognize if the transaction is correct or legitimate.

### SUMMARY OF THE INVENTION

The current invention is a system and method to help maintain an online banking accurate account balance. Paper checks may be drawn on the online checking account. Periodically the online banking account holder wants to find the true online checking account balance. The online checking account holder or payor can either take images, such as with a digital camera, scanner or an image producing and communicating device, such as a smart phone, of the check book or accounting register, or a digital copy can be made, of the checking or accounting books income, expense, deposit and withdrawal register. The image of the check book may be an individual's personal account and the digital copy of the accounting book's income/expense register may be that of a larger business.

In U.S. Pat. No. 8,676,706, Jones, et al., the account holder would take an image of the paper check each time it is written. Many people or businesses do not want to take the time or may not be able to take the image each time a check is written. The account holder may first look online at the account report to compare cashed checks with the checkbook stubs or register to see what written checks have not been cashed. The digital image may be processed by the account holder's recognition processing software, sometimes call Optical Character Recognition (OCR) software , or sent to the online banking financial institution, or the financial institution's third party processor, where number, symbol, print, type and written recognition software attempts to read the information of the checking account register. The account holder can send to the online banking account institution its recognition software processed attempted read checking and/or accounting book's income and expense register information. Alternatively the account holder can view the online account report where the financial institution's character recognition software attempted read checking and accounting book' register entries and has now been entered into the account's online report. A variance online banking report is generated that shows any entry variations from the account holder's registry data when compared to the online banking account entries. If the account holder knows some of the information is incorrect the account holder may be allowed to make corrections to the online checking account report. A more accurate account holder registry and balance can then be obtained along with the updated and corrected online variance report.

A further embodiment of the invention is to better identify the payee of a written check where the online reporting system will attempt to identify the registered name of the payee, the address of the payee and other merchant/banking data of the payee that would be useful to the account holder. The online banking report would give suggested payee names to the account holder for selections to identify the payee. The account holder may realize that that check was sent to the wrong payee or address.

Another embodiment of the invention may be that the online banking report system may be able to communicate to the payee to see if the payee has received the check. The online banking report system may even further be able to communicate to the payee if the payee intends to cash the check and possibly when the payee intends to cash the check.

The attempt to provide more transaction, deposit, withdrawal and other online banking account entry information to the account holder entails a further embodiment where more information about who the payee was and what was purchased plus possible information on income, expenses, deposit and withdrawals in further detail. Most of the online banking reports usually offer limited information about the entries. As the account holder is reviewing an online banking system report there may be a question as to whom and what was purchased, even trying to determine if there was a mistake in the billing, an alteration to the face of a check, a mistake in deposits and withdrawals or possibly an illegitimate purchase or billing where fraud was the case. Upon the request of the account holder the online banking system may be able to expand the purchases, income, expense, deposits and withdrawal entry information and may be able to communicate through the online banking account system with the payee, depositor and/or withdrawer; and/or view the transaction details, to obtain further information.

### BRIEF DESCRIPTION OF DRAWINGS

FIG. 1 in a diagram shows the check book or accounting register image, or digital copy, sent to the financial institution and then updated variance online banking account report communicated back to the account holder.

In FIG. 2 in a diagram, shows the online banking system providing expanded account transaction information.

### DETAILED DESCRIPTION OF THE DRAWINGS

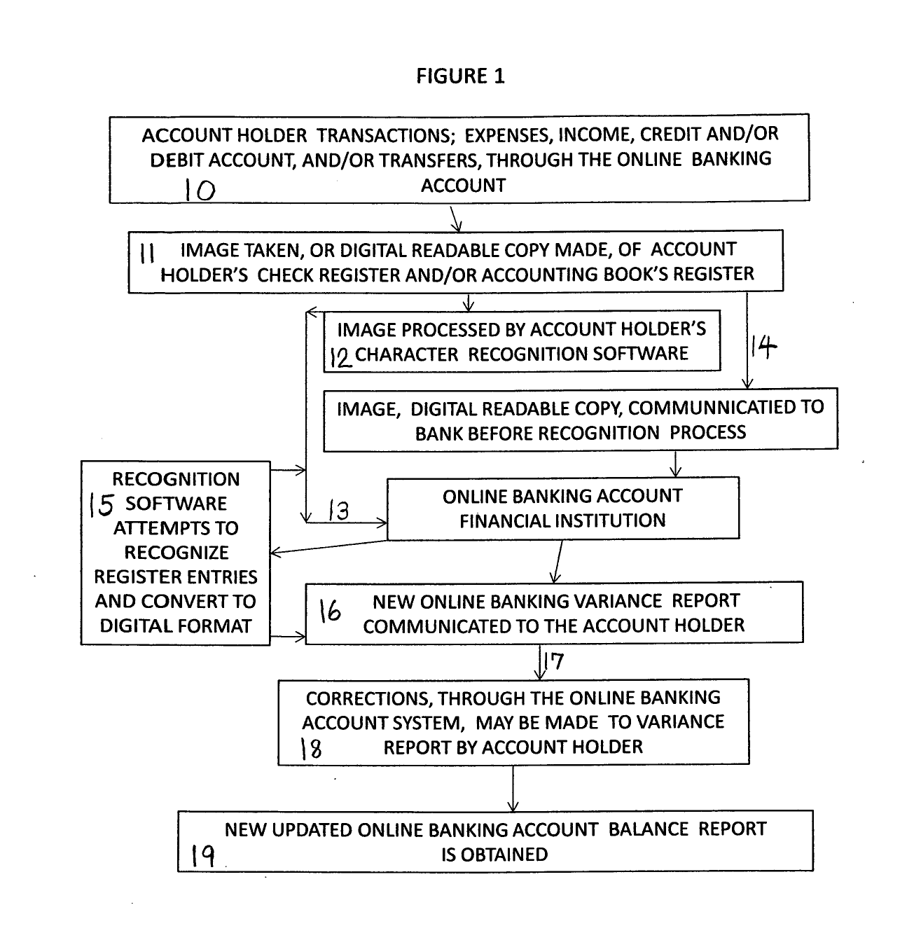

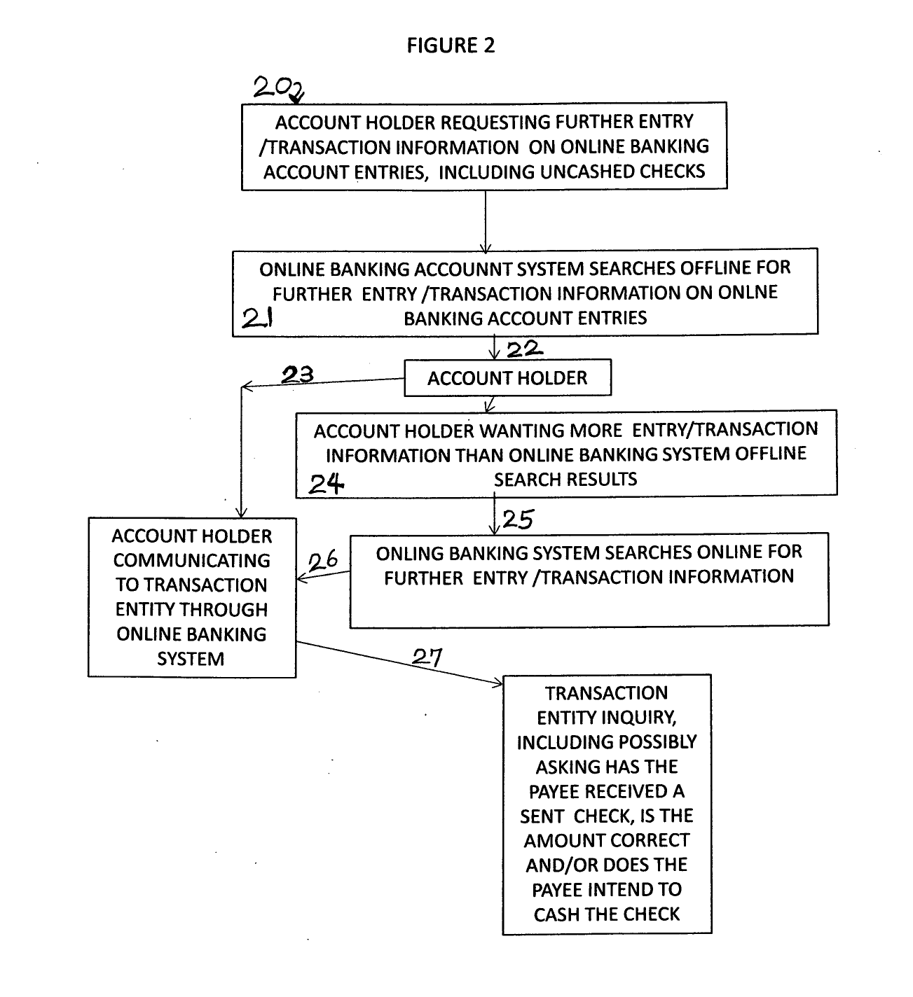

FIG. 1 in a diagram form shows the online banking account holder writing checks, paying directly with a debit or credit card account, paying online with debit or credit card account to a payee for items purchased, or other transaction; or deposits, withdrawals and/or transfers 10 in the check register and/or accounting book's income and expense register. Periodically the account holder or third party takes an image(s), or makes a digital readable copy of the check book stubs or register, or accounting book's income and expense register 11. The image, usually digital, is either processed by the account holder's recognition software system attempting to recognize the printed, typing, symbols, numbers and hand written various check book register entries, including any payee(s), date(s) written, check amount, what item(s) the check(s) were drawn, deposits and withdrawals information, in the account holder's check book register 12; and then the character recognition processed register entry data is communicated to the online banking account institution 13. Alternatively, the account holder communicates the image before recognition software processing, and/or the digital readable copy, of the register's entries to the online banking account financial institution, or financial institution third party provider 14. The online banking account financial institution or a third party processing provider uses printed, symbol, number and hand written recognition software to process the image, if not already recognition software processed by the account holder, to attempt to digitally recognize the check register entries from the check book image, which may include the payee(s), date(s) written, check amount, what item(s) the check(s) were drawn, deposits and withdrawals 15. The comparison of any differences between the account holder register entries and the online banking account entries creates a new online banking variance account report 16, which is then communicated to the account holder 17. The new online banking variance account report may then be corrected to by the account holder or the online banking system provides entry choices for the account holder to choose 18. A new updated more accurate online banking account balanced report is then obtained 19.

In a diagram, FIG. 2 shows first the account holder requesting further payee online banking account transaction information from the online banking account system to verify the online banking account entries 20. The online banking account system searches first offline for further online banking account transaction information requested by the account holder 21, and any offline searched data is communicated to the account holder 22. If the account holder is satisfied with the online banking account offline searched requested information, but the account holder may still want to contact the payee through the online banking system to further verify the correctness of the online banking account entries 23. If the account holder is not satisfied with the offline provided searched information 24 the account may requests the online banking system to search online to provide the requested payee transaction checking account information 25. The account holder may be satisfied with the online banking account offline searched requested information, but the account holder may want to contact the payee through the online banking system to further verify the correctness of the online banking account entries 26. The account holder may communicate to the contacted payee concerning checks that have not been cashed; has the payee received the check, is the amount correct and/or when does the payee intend to cash the check and when 27.

1. A system and method to balance and verify an online banking account, comprising the steps of:
a. the online banking account holder, or a third party, either takes an image(s), scans or reads by other means, the online banking account check book's stub or register, and/or the online banking account holder's accounting book's register or statement showing income, expenses, transfers and other accounting transactions entries that are also shown on the account holder's online banking statement;
b. the image, usually a digital image, of the holder's checking account register, and/or the online banking account holder's accounting book's register or income and expense statement, is either processed by the account holder's recognition software, sometimes called Optical Character Recognition (OCR) software, or account holder's third party processing provider, which attempts to recognize the printed, typing, symbols, numbers and hand written various check book register and/or accounting books register or income and expense statements entries, including any payee(s), date(s) written, check amount, what item(s) the check(s) were drawn, deposits and withdrawals information, and then communicated to the online banking financial institution, or;
c. the image, usually a digital image, before character recognition processing is communicated to the to the financial institution where the account holder has the online checking account, or to the financial institution's third party character recognition process provider;
d. the image of the account holder's checking account register, and/or the online banking account holder's accounting book's register or income and expense statement, is read by an image recognition software processor of the online account financial institution, or a third party provider, which recognition system attempts to recognize the printed, typing, symbols, numbers and hand written various register entries, including check numbers, payee(s), date(s) written, check amount, what item(s) the check(s) were drawn, deposits and withdrawals information, or;
e. the online banking account holder sends a digital readable copy of the check book register and/or accounting register or statement showing income and expenses entries, that should be shown on the online banking statement, to the online banking financial institution, or to the financial institution's third party processing provider;
f. the online banking report of the account holder's online banking account entries are compared to the account holder's check book register and/or account holder's accounting book's register or income and expense statements character recognition process information, or to the communicated digital readable copy, to determine; which paper checks are not shown as cashed by the payee, comparing income and expense entries, and deposits and withdrawals, transfers and/or other transactional entries to create a new online banking account variance report showing the combined account holder's register entries and online banking entries, plus delineating any discrepancies between the account holder's online banking account entries to the account holder's check book register and/or account holder's accounting book's register or income and expense statement's character recognition process entries, or to the digital readable sent copy;
g. the account holder may view the new banking account variance report;
h. the online banking account banking system may allow the account holder to directly correct certain online banking account variance report entry(s) information that is of question, including the not yet cashed check entries, and/or the online banking report system will give possible entry change suggestions for the account holder to choose;
i. a more accurate updated online banking account balanced report is then obtained.
1. A system and method to balance and verify an online banking account of claim 1 where more information about the payee and purchased items, income and expenses, deposits, withdrawals, transfer or other transactional information is requested by the account holder to help verify that account holder's registry entries and/or online banking account report transaction entries are correct, not mistakenly entered or fraudulently transacted, comprising the following steps:
a. the financial institution online banking account system allows the account holder to select previous online banking account transaction(s) to provide more information of the payee including; items purchased, billed amount of items purchased, or other information concerning income and expense, and/or deposit or withdrawal entries;
b. if the online banking account entry information request by the account holder is asking for more information on the payee transaction of a cashed or not yet cashed check then the online banking system searches offline in an attempt to provide to the account holder suggested payees with a possible address, contact information, transaction information, and the online banking system may let the account holder contact the payee/transaction, withdrawer, depositor and/or transferor directly through the online banking system, and the account holder may ask of a possible not yet cashed check payee; has the check been received, if you are the correct payee and/or when the check might be cashed;
c. if the online banking account entry information request by the account holder is asking for more information on the payee transaction than the offline search has provided of a cashed check or check that has not been cashed then the online banking system searches online to give the account holder suggested payees with a possible address, contact information and transaction information, and the online banking system may let the account holder contact the payee directly through the online banking system, when the account holder may ask of a possible not yet cashed check payee; has the check been received, if you are the correct payee and/or when the check might be cashed;
d. if the online banking account entry information request by the account holder is asking for more information of an expense, including credit or debit expenditures then the online banking system will search offline for the particular transaction extended online banking account expense information from the payee and my allow the account holder to contact the payee directly through the online banking system;
e. if the purchase/transaction information request by the account holder is asking for more information of an expense, including credit or debit expenditures than the offline search has provided then the online banking system will search online for the particular transaction extended expense information from the payee and my allow the account holder to contact the payee directly through the online banking system;
f. If the account holder is requesting more information about a deposit or withdrawal then the online banking system will search offline to provide expanded online banking account entry information concerning the deposit or withdrawal in question and the online banking system may allow the account holder to directly contact the depositor or withdrawer in question through the online banking system;
g. If the account holder is requesting more information about a deposit or withdrawal than the offline search has provided then the online banking system will search online to provide expanded information concerning the deposit or withdrawal in question and the online banking system may allow the account holder to directly contact the depositor or withdrawer in question through the online banking system.
